(19) United States
(12) Patent Application Publication
(10) Pub. No.: US 2024/0383819 A1
(43) Pub. Date: Nov. 21, 2024

(54) Dry Lubricants Mixed with Microbial Soil Amendments

(71) Applicant: Steven Shoup, New Plymouth, ID (US)

(72) Inventor: Steven Shoup, New Plymouth, ID (US)

(21) Appl. No.: 18/460,994

(22) Filed: Sep. 5, 2023

Related U.S. Application Data
(60) Provisional application No. 63/577,704, filed on May 15, 2023.

(51) Int. Cl. C05F 11/08; C05G 3/20; C05G 5/10

(52) U.S. Cl. CPC C05F 11/08; C05G 3/20; C05G 5/10

(57) ABSTRACT

Compositions and methods are provided for enhancing production in agriculture by mixing a microbe enriched soil amendment with a dry lubricant. Specifically, the microbe enriched soil amendment is mixed with a dry lubricant, and the mixture flows together and does not segregate due to agitation in an agricultural seeding mechanism.

### CROSS REFERENCE TO RELATED APPLICATION

This application claims priority to U.S. Provisional Application No. 63/577,704, filed May 15, 2023, which is incorporated herein by reference in its entirety.

### BACKGROUND OF THE INVENTION

Global food insecurity is a chronic issue that is likely to be aggravated with increasing population growth and by the deceasing availability of arable land. Over the last 50 years, fertilizer and pesticides have been used to artificially stimulate plant growth and suppress harmful pathogens that can destroy crops and reduce yields. However, intensive use of agrochemicals has led to an increasing dependence on artificial nutrients, an increase in trapped nutrients in challenged soils, and rampant expansion of crop-destroying soil-borne diseases, pathogenic organisms and destructive parasitic nematodes. The net result has been significant destruction of natural and vital soil microbial activity.

Decades of using toxic, chemically engineered fertilizers, pesticides, and soil amendments have severely damaged and sterilized agricultural soil systems and contaminated surface waters and aquifers. The accumulation of these chemicals in our food and water supply has contributed to a dramatic increase in cancers, diseases, and cognitive issues in humans and wildlife. Consequently, growers are seeking cost effective, organic alternatives to chemical-based fertilizers, pesticides, and soil amendments.

All of this has resulted in a material reduction of crop yields and nutrient quality and creates a need for highly effective natural soil remediation and restorative solutions. In an effort to support a pathway to longer-term sustainable and regenerative agricultural practices, companies have developed all-natural, organic and powerful natural fertility soil solutions.

Plant growth promoting microorganisms have been demonstrated to enhance plant productivity and increase crop yields. Soil amendments have been formulated that contain microbes. The rhizosphere is the soil region subject to the influence of plant roots. In naturally fertile soils, the rhizosphere can be home to a rich diversity of microorganisms, many of which benefit plants by suppressing pathogenic invasions and helping to acquire vital nutrients from the soil. These microbes create a defensive barrier around the plant roots that significantly reduce soilborne pathogens and plant parasitic nematodes. As well, microorganisms that live on or near the plant root systems can significantly improve nutrient absorption and water retention of the soil. In addition, the microbes activate soil nutrients and releases bound natural fertilizers to produce more nutritious crops and enhance plant growth.

Notwithstanding the obvious benefits, the soil amendments containing microbes are most effective when directly applied to the rhizosphere and plant roots. Applying microbial soil amendments have the highest efficacy when the capability exists to apply them within the rhizosphere of the seed at planting time. The most effective mode of delivery of beneficial microbes is to get the microbes as close to the plant seeds as possible and on the roots as soon as soon as the seeds germinate, which will provide the most protection and benefit for the plant. Thus, optimized, efficient, and reliable microbial application methods are needed.

Most seeds in agricultural plantings are coated with various inorganic fungicides and other chemicals. These coatings are hygroscopic and readily absorb moisture from the atmosphere and the high volumes of air moving through air planters. Agricultural talc is typically used at crop planting time and applied in seed hoppers located on planting implements to act as a dry lubricant, but its primary role is a drying agent. The fans in air-based seed metering systems move tremendous volumes of air. Even low levels of humidity in the air are magnified by high air flow and can cause problems with coatings commonly applied to seeds. When the seeds absorb moisture, their surfaces become sticky, leading to problems with seed clumping and bridging in seed hoppers and clinging to seed disks in seed meters. Thus, talc smooths and dries the surfaces of the seeds and improves flowability in the seed planters.

Most crops are planted with the use of seed planters. Thus, agricultural talc acts as a dry lubricant by farmers in their seed planters during the planting of their seed crops. Most planters require the use of talc or graphite to lubricate the seed plates to facilitate the flow of the seeds as the seeds get planted into the ground. The dry lubricants decrease wear in mechanical seeding mechanisms. Graphite can greatly reduce friction in those units and increases component life. Talc can also be used as an effective lubricant.

In addition, as plastic metering disks turn in seed meters, static electricity typically develops on the surfaces of seeds jostling in the bottom of the hoppers, or as they rattle through plastic seed delivery tubes. The static electrical charges can cause seeds to clump and bridge. Fortunately, talc and graphite have anti-static characteristics. Talc is an insulator, minimizing the buildup and transfer of static electricity. Graphite is a conductor, easily transferring to a ground within a planter's components any static electricity that may develop. Thus, a mix, such as an 80/20 mix of talc and graphite, is typically used in air planters to provide seed drying capabilities, optimal mechanical lubrication, and static electricity control. Although in many planters, talc alone is utilized without graphite.

The ability to effectively combine both organic microbes and talc into a single formulation provides substantial benefit to farmers in ensuring effective in-furrow distribution of microbes at planting time. With such a solution, the microbes have close contact to the seeds; and as soon as there is enough water to germinate the seed, the water will also awaken microbes that have been applied into the talc that coats the seeds at planting.

The problem exists that dry seed lubricants, typically talc or graphite, are ground extremely fine. Thus, in order to get the beneficial microbes to flow well, the microbes also need to be at a gradation zone of approximately the same size as the utilized lubricant. In addition, the unit weight of the microbial soil amendment powder will need to be reasonably close to the lubricant's unit weight. If the size gradation and unit weights are not approximately similar, the lubricant and the microbial amendment will segregate and will not flow well together and result in uneven distribution of microbes within the planting furrow.

As well, if the size gradation and unit weight of the talc and microbial dry formulation are substantially different, the microbial soil amendment can separate from the dry lubricant mix (talc and/or graphite) during the significant agitation found in most commercial seed planters and related equipment. However, milling the microbial soil amendment into such extremely fine consistency typically kills a significant portion of the beneficial microbes. Consequently, milling a microbial soil amendment into an extremely fine consistency needs to be accomplished in a manner that preserves the viability of the beneficial microbes.

### BRIEF SUMMARY OF THE INVENTION

The present invention discloses compositions and methods in various embodiments of enhancing production in agriculture. The methods comprise of mixing a microbe enriched soil amendment with a dry lubricant. The soil amendment and the lubricant will flow together and do not segregate due to agitation in an agricultural seeding mechanism. The dry lubricant typically includes talc, graphite, or a mixture of talc and graphite.

In one embodiment, the microbe enriched soil amendment has a maximum particle size less than 100 microns. This particle size is achieved by using a screening mechanism in conjunction with an assortment of low density milling medium. The particle size is easier to achieve by using a first screening mechanism that is coarser than a second finer screening mechanism. A 150-mesh or finer screen achieves the requisite micron size. However, in order to prevent clumping, the mixing of the microbe enriched soil amendment with the dry lubricant is performed at a temperature less than 76 degrees Fahrenheit and/or less than 33% humidity.

The present invention also discloses a composition comprising a microbial enriched soil amendment and a dry lubricant. The soil amendment and the lubricant will flow together and do not segregate in an agricultural mechanical seeding mechanism. The dry lubricant includes talc, graphite, or a mixture of talc and graphite. This composition increases lubricity of the seeds in an agricultural crop planter.

In this embodiment, the microbe enriched soil amendment has a maximum particle size less than 100 microns. The particle size is achieved by using a screening mechanism in conjunction with an assortment of low density milling medium. A plurality of differing sizes of flexible nylon balls is used as the low density milling medium. Again, a 150-mesh or finer screen is used as the screening mechanism to achieve a particle size less than 100 microns. The particle size is most easily achieved by using a first screening mechanism that is coarser than second screening mechanism.

The present invention further discloses a method for mixing a microbe enriched soil amendment with a dry lubricant. This method comprises of lyophilizing a microbial medium, milling the microbial medium, shaking the microbial medium through a screening mechanism, mixing the microbial medium with a dry lubricant, and packaging the microbial medium. Using the disclosed process, the microbial medium and the lubricant flow together and do not segregate due to agitation in an agricultural seeding mechanism.

In this embodiment, the dry lubricant includes talc, graphite, or a mixture of talc and graphite. The various steps of milling the microbial medium, shaking the microbial medium through a screening mechanism, and mixing the microbial medium with a dry lubricant are performed at a temperature less than 76 degrees Fahrenheit and/or less than 33% humidity to prevent clumping. Using this process, the microbial count of the microbial medium after the mixing is greater than 50% of the count of microbes before the lyophilizing.

### BRIEF DESCRIPTION OF THE DRAWINGS

Various embodiments are illustrated by way of examples in the figures of the accompanying drawings. Such embodiments are demonstrative and not intended to be exhaustive or exclusive embodiments of the present subject matter. The drawings are not necessarily to scale, emphasis instead being placed on illustrating the principals of the invention.

FIG. 1 is a flow chart depicting the major steps of the preferred embodiment of the present invention.

FIG. 2 depicts the step of lyophilization of the microbial medium.

FIG. 3 depicts the step of removing the microbial medium from the lyophilization trays.

FIG. 4 depicts the step of crumbling the microbial medium.

FIG. 5 depicts the step of milling the microbial medium.

FIG. 6 depicts the step of shaking the microbial medium into a fine powder using an assortment of low-density balls.

FIG. 7 depicts the step of shaking the microbial medium into an extremely fine powder of less than 75 microns.

FIG. 8 depicts the step of mixing the microbial medium with a lubricant.

FIG. 9 depicts the step of diluting the final microbial medium.

### DETAILED DESCRIPTION OF THE INVENTION

The description that follows includes compositions, systems, methods, and apparatuses that embody various elements of the present disclosure. However, it should be understood that the described disclosure may be practiced in a variety of forms in addition to those described herein. Accordingly, the referenced drawings show, by way of illustration, specific embodiments in which the invention may be practiced. It is to be understood that other embodiments may be utilized, and structural changes may be made without departing from the scope of the claims. It is further understood that the steps described with respect to the disclosed processes may be performed in differing order and are not limited to the steps presented herein.

The present disclosure provides compositions and methods in various embodiments for enhancing agricultural production. The methods include mixing a microbe enriched soil amendment with a dry lubricant such that the resulting composition will flow together and do not segregate due to agitation in an agricultural seeding mechanism.

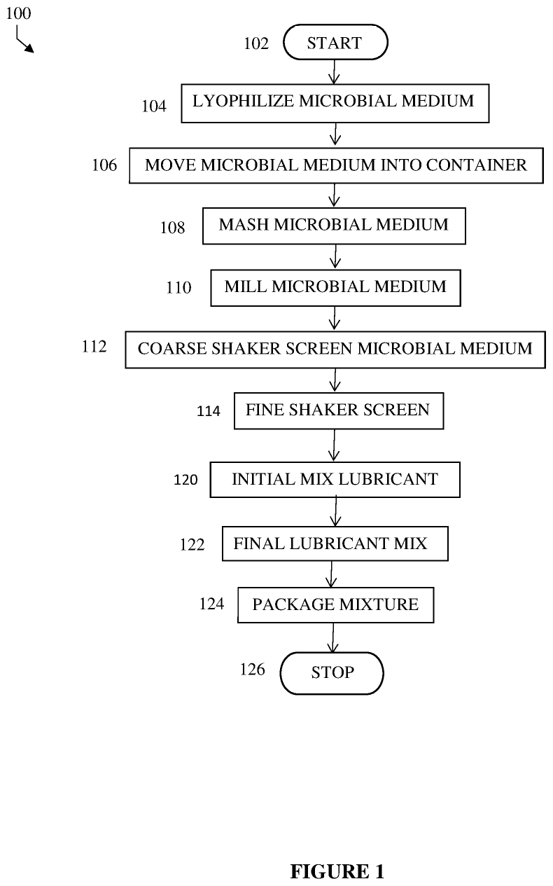

Referring to FIG. 1, illustrated is a flowchart 100 for the steps of mixing a microbe enriched soil amendment with a dry lubricant such that the resulting composition will flow together and do not segregate due to agitation in an agricultural seeding mechanism.

The process starts in step 102. At this step, a microbial solution has been previously brewed to greatly increase the concentration of the microbes. A lyophilization buffer, as known in the art, has been added to the microbial solution to create a microbial medium that can be lyophilized without destroying most of the microbes.

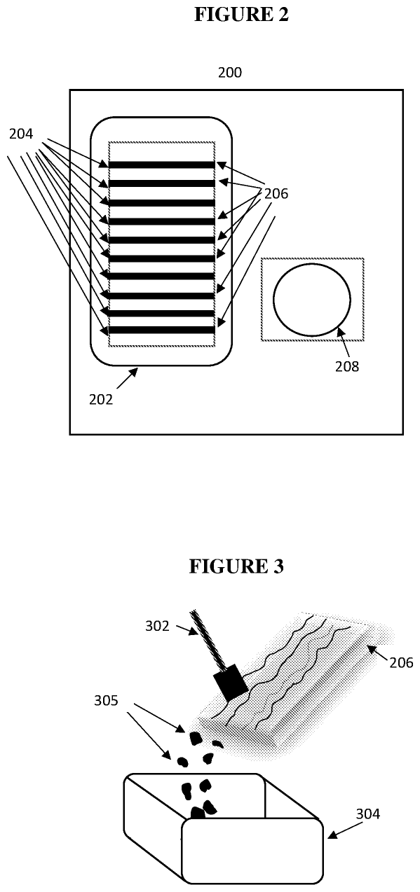

In step 104, the microbial medium is lyophilized as depicted in reference to FIG. 2. After brewing the microbials, the microbes are dried and preserved by lyophilization. The microbes are suspended in an excipient that helps to maintain their viability through freezing, water removal, and subsequent storage. This buffer helps to form an “airy cake” which gives body to the microbial suspension once freeze dried.

In step 106, the post lyophilized microbial medium is transferred into a container as depicted in reference to FIG. 3. After lyophilizing, the microbial medium is removed from the trays. After removing the microbial medium from the lyophilizer, the environment should be controlled to be less than 75° F. and less than 33% humidity. Outside of those parameters, the medium tends to absorb water, and thus, creating a fine powder is extremely difficult.

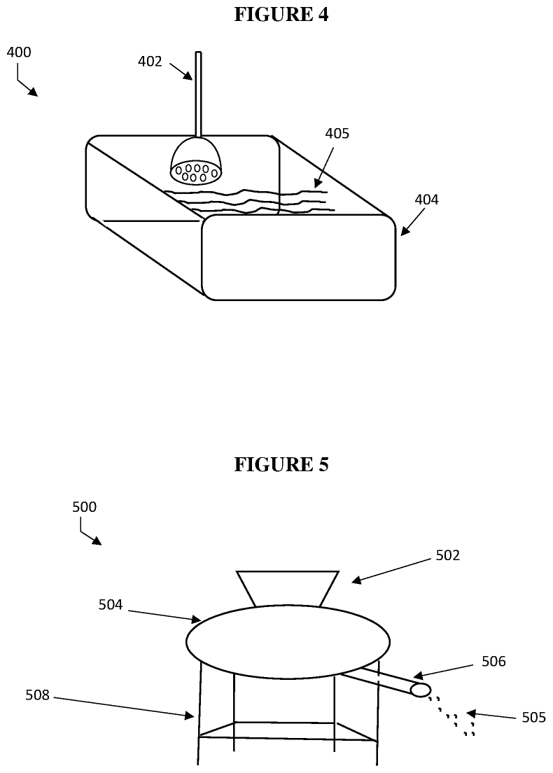

In step 108, the post lyophilized microbial medium is ground into crumbs as depicted in reference to FIG. 4. In the preferred embodiment, the microbial medium has an airy cake texture and easily obtains a crumbly consistency with slight pressure.

In step 110, the crumbs are poured into a brewer's grain mill as depicted in reference to FIG. 5. The microbial medium leaves the brewer's mill as a coarse powder.

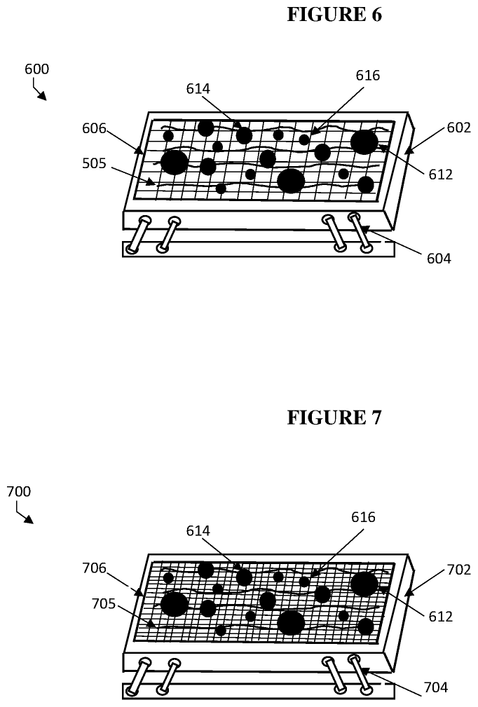

In step 112, the coarse powder is turned into a finer power by use of a first shaker deck as depicted in reference to FIG. 6.

In step 114, the finer powder is buffeted into an extremely fine power by use of a second shaker deck as depicted in reference to FIG. 7. The various microbes range in size but some are as large as 75 microns. Grinding the microbes to smaller sizes than 75 microns will kill some of the larger microbes. Thus, in order to get the beneficial microbes to flow well and not kill significant number of the larger microbes, a 200 US mesh is used. This mesh size creates a particle size of approximately 74 microns, which will allow most of the beneficial microbes to survive. Since the size and unit weights of the lubricants (typically agricultural talc and/or graphite) and microbes are reasonably close at 200 US mesh, the lubricant and the microbes do not segregate and effective flows of the combined product are achieved. Depending on the talc, it may be possible to use 150 US mesh screen achieving a 100 micron maximum size particles.

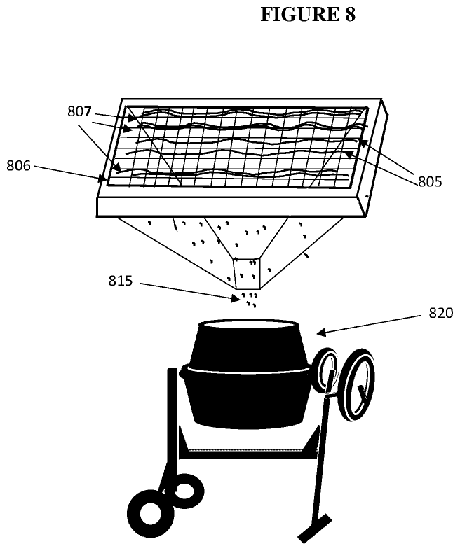

In step 120, the extremely fine powder is mixed with a dry lubricant as depicted in reference to FIG. 8. The mixing of the microbial powder needs to be done in a cool low humidity environment. The extremely fine microbial powder mixture has a tendency not to blend if the humidity is over 33% and/or the temperature over 75 degrees Fahrenheit.

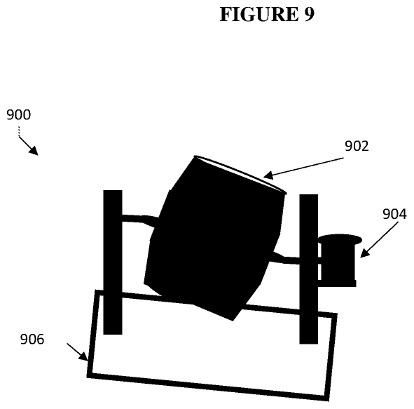

In step 122, the extremely fine powder mixture is further diluted and thoroughly mixed to the desired final composition mixture as depicted in reference to FIG. 9.

In step 124, the final product is packaged. Agricultural lubricants are typically sold in 7 or 8 pound buckets and bags. After packaging, the mixture is ready for sale and the process ends as shown in step 126.

Referring to FIG. 2, the step of lyophilizing 104 the microbial medium is depicted. The microbial medium is poured into trays 206 and placed on the shelves 204 in the vacuum chamber 202 of the lyophilizer 200 for dehydration. A motor (not shown) is in place to ensure the vacuum chamber 202 is vacuum-tight when closed. The condenser 208 consists of refrigerated coils or plates. During the drying process, ice moves from the frozen product to the condenser by sublimation.

Referring to FIG. 3, depicted is the step of transferring 106 the post lyophilized microbial medium 305 from the lyophilization tray 206 into a container 304. In this embodiment, a spatula 302 is used to scrape the lyophilized medium 305 from the tray 206. The microbial medium 305 ideally has an airy cake texture that easily obtains a crumbly consistency with slight pressure.

Referring to FIG. 4, depicted is the step of the lyophilized microbial medium 305 being ground into crumbs 405. In this embodiment, a mallet 402, such as a potato masher, gently crushes the microbial medium 305 into crumbs 405.

Referring to FIG. 5, the step of pouring 110 the crumbs 405 into a brewer's grain mill 500 is depicted. The brewer's mill is supported by a stand 508. The microbial medium crumbs 405 are poured into the mill's funnel 502. In this embodiment, the brewer's mill 500 uses two stainless steel slow rollers (not shown) inside the mill's roller bin 504 gapped at approximately one millimeter. The microbial medium crumbs 405 leaves the brewer's mill by the exit tube 506 as a coarse powder 505.

Referring to FIG. 6, the step is depicted of turning 112 the coarse powder 505 into a finer power 705 by use of a first shaker mechanism 600. On the shaker deck 602, non-metallic ball bearings 612, 614, 616 gently push the cake 605 down on a stainless steel screen 606. A shaking mechanism 604 shakes the screen 602. Shaking the coarse microbial powder 605 through a shaker screen 606 using a 20-mesh or finer screen creates a finer powder 705. An assortment of low-density spherical milling medium 612, 614, 616 is used to buffet the coarse powder 505. Lightweight nylon balls 612, 614, 616 are the preferred medium to buffet the microbial powder 505. On the shaker deck 602, the ball bearings 612, 614, 616 gently push the microbial cake down on the screen 606. An assortment of flexible nylon balls ranging from a quarter (¼) inch diameter 616 to a half (½) inch diameter 614 to a one (1) inch diameter 612 is preferred.

Referring to FIG. 7, the step of buffeting 114 the finer powder 705 into a an extremely fine power 805 by use of a second shaker mechanism 700 is depicted. On the second shaker deck 702, the ball bearings 612, 614, 616 gently push the microbial powder on the shaker screen 706. A shaking mechanism 704 shakes the shaker deck 702. Shaking the microbial powder 705 using a 150-mesh or finer screen is preferred creating an extremely fine powder 805. An assortment low density spherical milling medium 612, 614, 616 is used to buffet the microbial medium 705. The nylon balls 612, 614, 616 need to be light weight in order to not damage the screen or crush the microbes. On the shaker deck 702, the ball bearings 612, 614, 616 gently push the microbial cake down 705 through the stainless-steel screen 706. An assortment of nylon balls ranging from a quarter (¼) inch diameter 616 to a half (½) inch diameter 614 to a one (1) inch diameter 612 is preferred. Heavy balls can destroy the microbes and create damage to the screen.

In order to get the beneficial microbes to flow well and not kill significant number of the larger microbes, a US 200 mesh is preferred. This mesh size creates a particle size of approximately 74 microns, which will allow most of the beneficial microbes to survive. Depending on the lubricant, it may be possible to use 150 US mesh screen achieving a 100 micron maximum size particles.

Referring to FIG. 8, the step of mixing 120 the extremely finer powder 805 with a dry lubricant 807 is depicted. In this step 120, the extremely fine microbial powder 805 and lubricant 807 are placed onto another vibrating screen 806. The process mixes the two to form a blend 815 of the two powders.

In this embodiment, the extremely fine microbial powder 805 and the lubricant 807 are spread across the screen 806 using a ratio of 2 or 3 units of lubricant to 1 unit of fine microbial powder. The screen 806 is vibrated such that the microbial powder 805 and the lubricant 807 both flow into a conical mixer 820 that rotates constantly. The process of mixing the microbial medium 805 with a lubricant 807 works much better if the extremely fine microbial powder 805 is kept in near constant motion.

Referring to FIG. 9, the step of further diluting 122 the mixed powder 815 is depicted. The premixed microbial lubricant powder 815 is further integrated into an end over end tumbler 900 until well mixed achieving the final desired dilution rate such as 5 parts lubricant 807 to 1 part extremely fine microbial powder 805. The tumbler 900 sitting on its stand 906 should have enough space inside the chamber 902 for the mixture to become airborne to allow optimal mixing. A motor 904 tumbles the end over end tumbler. After leaving the tumbler, the final product is ready to be packaged. The final microbial lubricant mix can be used in a agricultural mechanical seeding mechanism, such as a seed tender or a crop seeder, in the same manner as the lubricants without the microbial mixed.

1. A method of enhancing production in agriculture, wherein the method comprises mixing a microbe enriched soil amendment with a dry lubricant, wherein the soil amendment and the lubricant flow together and do not segregate due to agitation in an agricultural seeding mechanism.

2. The method of claim 1, wherein the dry lubricant includes talc, graphite, or a mixture of talc and graphite.

3. The method of claim 1, wherein the microbe enriched soil amendment has a maximum particle size less than 100 microns.

4. The method of claim 3, wherein the particle size is achieved by using a screening mechanism in conjunction with an assortment of low density milling medium.

5. The method of claim 4, wherein the screening mechanism is a 150-mesh or finer screen.

6. The method of claim 1, wherein the mixing of a microbe enriched soil amendment with a dry lubricant is performed at a temperature less than 76 degrees Fahrenheit or less than 33% humidity.

7. The method of claim 3, wherein the particle size is achieved by using a first screening mechanism and a second screening mechanism, wherein the first screening mechanism has a coarser screen mesh than the second screening mechanism.

8. A composition comprising a microbial enriched soil amendment and a dry lubricant, wherein the soil amendment and the lubricant flow together and do not segregate in an agricultural mechanical seeding mechanism.

9. The composition of claim 8, wherein the dry lubricant includes talc, graphite, or a mixture of talc and graphite.

10. The composition of claim 8, wherein the microbe enriched soil amendment has a maximum particle size less than 100 microns.

11. The composition of claim 10, wherein the particle size is achieved by using a screening mechanism in conjunction with an assortment of low density milling medium.

12. The composition of claim 11, wherein the screening mechanism is a 150-mesh or finer screen.

13. The composition of claim 10, wherein the particle size is achieved by using a first screening mechanism and a second screening mechanism, wherein the first screening mechanism has a coarser screen mesh than the second screening mechanism.

14. The composition of claim 8, wherein the assortment of low-density milling medium comprises a plurality of differing sizes of non-metallic balls.

15. The composition of claim 8, wherein the composition increases lubricity of the seeds in an agricultural crop planter.

16. A method for mixing a microbe enriched soil amendment with a dry lubricant comprising: lyophilizing a microbial medium, milling the microbial medium, shaking the microbial medium through a screening mechanism, mixing the microbial medium with a dry lubricant, and packaging the microbial medium.

17. The method of claim 15, wherein the dry lubricant includes talc, graphite, or a mixture of talc and graphite.

18. The method of claim 15, wherein the milling the microbial medium, the shaking the microbial medium through a screening mechanism, and the mixing the microbial medium with a dry lubricant are performed at a temperature less than 76 degrees Fahrenheit or less than 33% humidity.

19. The method of claim 15, wherein a microbial count of the microbial medium after the mixing is greater than 50% of a count before the lyophilizing.

20. The method of claim 15, wherein the microbial medium and the lubricant flow together and do not segregate due to agitation in an agricultural seeding mechanism.
